(19) United States
(12) Patent Application Publication
(10) Pub. No.: US 2003/0163809 A1
(43) Pub. Date: Aug. 28, 2003

(54) Automatic provisioning for subscription computing

(75) Inventors: David F. Bantz, Chappaqua, NY (US); Thomas E. Chefalas, Somers, NY (US); Joshua Furman, New City, NY (US); Alexei A. Karve, Mohegan Lake, NY (US); Steve J. Mastrianni, Unionville, CT (US); Ajay Mohindra, Yorktown Heights, NY (US); Dennis G. Shea, Ridgefield, CT (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/085,547

(22) Filed: Feb. 27, 2002

(51) Int. Cl. G06F 9/445

(52) U.S. Cl. 717/177

(57) ABSTRACT

The present invention is directed toward a method, computer program product, and data processing system for providing automatic, mass-customized preparation of disk images. The invention relies on a front end, which interacts with customers and sales personnel to acquire self-consistent provisioning requirements. These requirements are input to a provisioning engine, which uses a knowledge base of constraints and affinities to generate a set of provisioning orders. These orders are input to a disk image builder, which automatically creates the disk image and saves it for distribution. The disk image builder also consults a knowledge base concerning best practices established by the service provider for disk image builds. Finally, the requirements are used to drive a disk image tester, which exercises the image as a quality inspection.

### BACKGROUND OF THE INVENTION

1. Technical Field

The present invention relates generally to the installation of software on computers. More specifically, the present invention is directed toward the creation of customized disk images that may be installed in a turnkey fashion on multiple computers.

2. Description of Related Art

Subscription computing, also known as IT Outsourcing, is a business model for providing information technology (IT) to a customer. Under this model, the provider provides a comprehensive package of hardware, software, services and support. Subscription computing can be thought of as one-stop shopping for an entire IT infrastructure. The provider delivers computing and network hardware to the customer and provides software, services, and support from one or more sites remote to the customer. This model is advantageous to the provider because it permits economies of scale. Subscription computing is particularly useful for customers without professional IT configuration and administration personnel. These customers are often small businesses.

A key capability required for subscription computing is the mass customization of workstation and server software for delivery to the customer. This customization step is referred to as preparation of a “disk image.” The disk image contains ready-to-run versions of the operating system, the applications, utility programs, and data. The disk image is copied onto the hard disks of the workstations and servers prior to their delivery to the customer, or it may be provided to a server on the customer's premises for distribution to the customer's workstations and servers. Distribution of a disk image avoids the complex, time-consuming and delicate process of installing each of the software components, one after the other, on each workstation or server. The work is done once under controlled conditions, resulting in a single disk image that may be applied to multiple machines in a “turnkey” fashion.

An image is created initially by dedicating a workstation to the image creation task. Many means of preparing such an image exist. The operating system, device drivers, patches, updates, and other configuration options are installed. Then individual applications and utilities are installed. The result is tested to see if the various components will coexist. When the image build is deemed satisfactory, programs such as Symantec Ghost (available from Symantec, Inc. of Cupertino, Calif.) can capture a disk image from the dedicated workstation so that it can be copied to other workstations. This process is labor-intensive, time-consuming (often taking weeks) and is limited to target workstations of the same type and configuration as the workstation on which the disk image was prepared. Little if any customization is possible for the target workstations.

A subscription computing service provider will serve many small customers, each with unique needs for software. These needs arise because of factors that include the specific training customer personnel have on specific software products, the industries that the businesses serve, differing workstation requirements of the businesses, and individual businesses' preferences. Hence, disk images must be customized for each customer. Because these customers are often small and represent a relatively small incremental revenue to the provider, however, it becomes costly to the provider to undertake the complex, labor-intensive and time-consuming process of preparing a unique disk image for each customer. In fact, the problem is even more complex, because different disk images may be required in a single customer organization, based on the customer's organizational structure.

Prompt service is also an important ability for a provider. A customer that must wait for service can cancel its subscription as easily as it subscribes. Any delay in creating customized disk images, therefore, has the potential to adversely affect revenue. A way to easily construct customized disk images in a subscription computing environment is needed.

### SUMMARY OF THE INVENTION

The present invention is directed toward a method, computer program product, and data processing system for providing automatic, mass-customized preparation of disk images. The invention relies on a front end, which interacts with customers and sales personnel to acquire self-consistent provisioning requirements. These requirements are input to a provisioning engine, which uses a knowledge base of constraints and affinities to generate a set of provisioning orders. These orders are input to a disk image builder, which automatically creates the disk image and saves it for distribution. The disk image builder also consults a knowledge base concerning best practices established by the service provider for disk image builds. Finally, the requirements are used to drive a disk image tester, which exercises the image as a quality inspection.

One particular value of the present invention to subscription computing service providers is that it both reduces the cost of any customization required, and reduces the time to accomplish that customization. Minimum human labor is involved. Requirements can be captured directly from the customer, improving accuracy and increasing customer satisfaction through a better understanding of the customization options that are available. From a business perspective, the invention permits the service provider to serve more and smaller customers.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram depicting components of an automatic provisioning system for subscription computing in accordance with a preferred embodiment of the present invention;

FIG. 2A is a diagram depicting the gathering of requirements information in accordance with a preferred embodiment of the present invention;

FIG. 2B is a diagram depicting a fragment of a customer requirement made in accordance with a preferred embodiment of the present invention;

FIG. 3 is a diagram depicting components of the automatic provisioning system that generate and test the disk image in accordance with a preferred embodiment of the present invention;

FIGS. 4A-4D are diagrams depicting knowledge base rules in accordance with a preferred embodiment of the present invention;

FIG. 5 is a flowchart representation of the execution of software in a provisioning engine in accordance with a preferred embodiment of the present invention;

FIG. 6 is a flowchart representation providing a detailed view of a process of generating provisioning orders in accordance with a preferred embodiment of the present invention;

FIG. 7 is a flowchart representation of the execution of software on a disk image manufacturing server in accordance with a preferred embodiment of the present invention; and

FIG. 8 is a flowchart representation of the execution of software on a disk image testing server in accordance with a preferred embodiment of the present invention.

### DETAILED DESCRIPTION OF THE PREFERRED EMBODIMENT

FIG. 1 is a diagram depicting the components of an automatic provisioning system for subscription computing in accordance with a preferred embodiment of the present invention. A customer 10 is shown interacting with a graphical user interface 11, preferably implemented using a personal computer (PC). This graphical user interface allows the customer to choose among alternative software components to customize the disk image for his or her needs. The PC supporting this graphical user interface is also connected to the Internet (15) so that the customer's selections may be transmitted to subscription computing service provider 20. Subscription computing service provider 20 has facilities housing servers 22, 23 and 24 capable of analyzing customer 10's requirements and constructing a customized disk image 25. Customized disk image 25 will be loaded onto PC 30 for shipment to the customer.

It is the intention of this invention to support the customer specification of disk images in terms of the customer's needs, rather than requiring the customer to list each and every software component that will be required in the disk image. For example, a customer may simply require that the disk image contain software capable of viewing files encoded in the Adobe Systems Portable Document Format (PDF), rather than specifying that the disk image contain Adobe Acrobat version 4.05, which is a particular program that can view such files. This permits the provisioning system to select components for the disk image of the appropriate version, functional characteristics, and resource consumption, also subject to cost constraints specified by the customer.

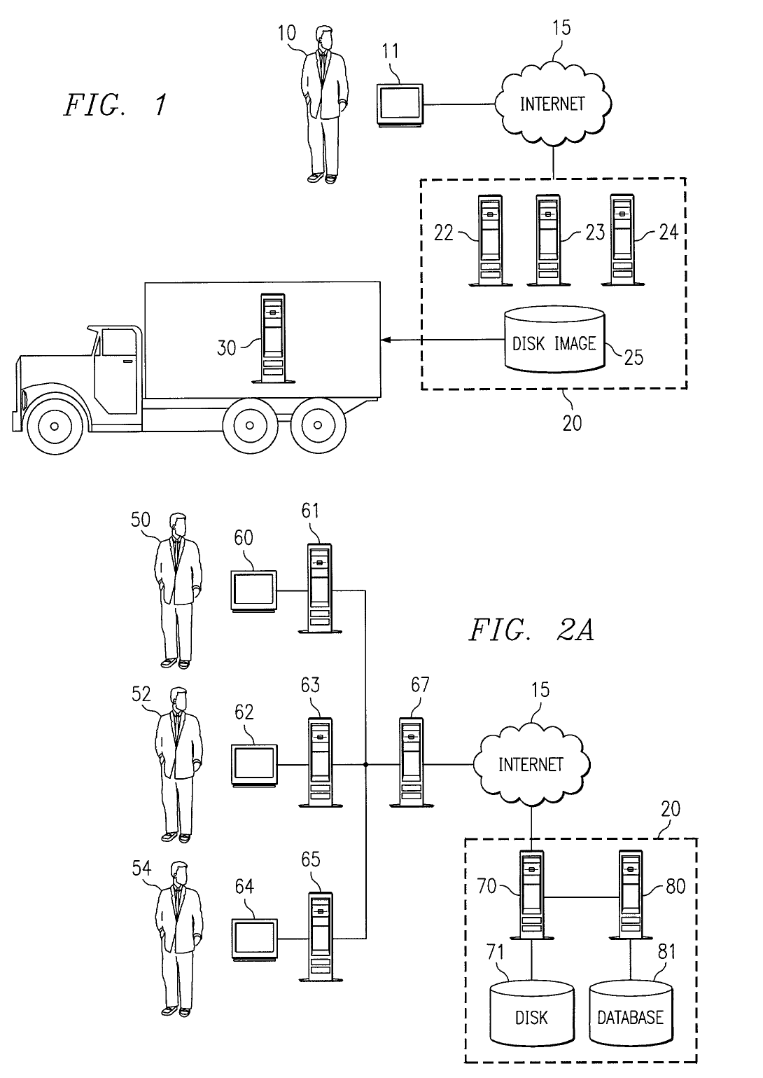

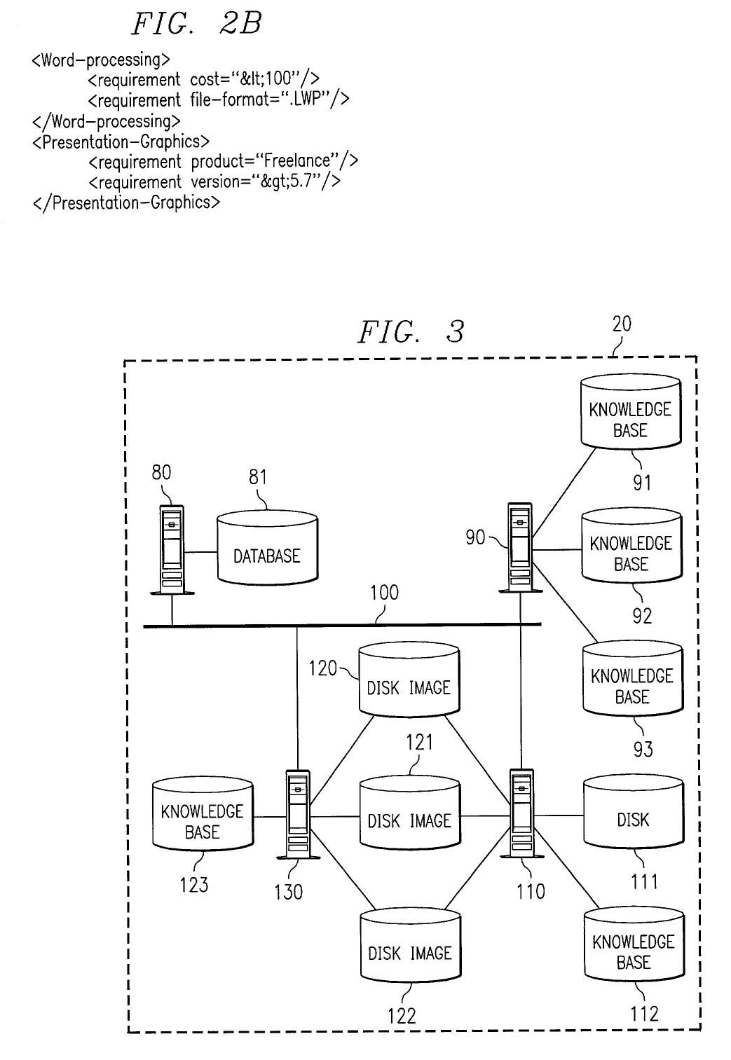

FIG. 2A elaborates FIG. 1 for the purposes of describing how the requirements for the disk image are gathered in a preferred embodiment of the present invention. In FIG. 2A are shown users 50, 52 and 54 all presumed to be employees of an enterprise for whom the disk image will be constructed. For example, user 50 may be a manager or owner of the enterprise, user 52 may be the system administrator for information technology for the enterprise, and user 54 may be a representative of the department for which the disk image is being constructed. Each of users 50, 52 and 54 creates some component of the requirements for the disk image using graphical user interfaces 60, 62 and 64 attached to PCs 61, 63 and 65, respectively. The enterprise manager may select software relevant to the industry segment served by the enterprise, the system administrator may select software relevant to his needs in administering and maintaining all of the PCs in the enterprise, and the departmental representative may select software pertaining to the functional needs of his department. In a preferred embodiment of the invention, the graphical user interface is a hypertext browser. Server 70, located on the premises of subscription computing service provider 20, creates and transmits the elements of the graphical user interfaces 60, 62 and 64 to PCs 61, 63 and 65, respectively using the HyperText Transfer Protocol (HTTP) and in the HyperText Markup Language (HTML). User selections are transmitted, preferably using the same protocol and language, to server 70.

Server 70 is preferably a server running Web application server software, for example, the IBM WebSphere server software available from IBM Corporation of Armonk, N.Y. Mini-applications, or servlets, run in a context established by this software in response to user requirements received from users 50, 52 and 54, and cause the storage of these requirements in database 81 via database server 80. Database server 80 is preferably a server running database software, for example, the IBM DB2 server software, also available from IBM Corporation. In this manner user requirements are acquired from users 50, 52 and 54 and stored in database 81.

Server 70 may customize the HTML that it generates to create the graphical user interfaces 60, 62 and 64 in any manner, but preferably in response to information received prior to the requirements acquisition for a disk image, which is stored on disk 71. This information may include, but is not limited to, the hardware and software of customer PCs that will receive the disk image, cost constraints, and past disk image requirements. This information may be used to limit the options presented to those that are compatible with the equipment configuration and cost constraints of the customer. It may be used to order the options presented in a manner consistent with past customer behavior. For example, more commonly selected options may be presented first.

Note that there is no need for the components of the requirements for the disk image to be transmitted to database 81 simultaneously. Rather, these requirements can be accumulated over time. Preferably, there are user interface elements displayed to users 50, 52 and 54 requiring their signoff or approval of those components of the requirements that they are responsible for. When all of these signoffs have been received, database 81 triggers subsequent processing on the servers of subscription computing service provider 20 to create the disk image. Database 81 contents will also be used subsequently to test the disk image.

FIG. 2B gives an example of a fragment of a customer requirement in accordance with a preferred embodiment of the present invention. The fragment is represented in the eXtensible Markup Language (XML). XML is a well-known and largely user-defined language for imposing structure on textual data. The first part of the XML, between the “Word-processing” tags, concerns the choice of word processor. The customer is willing to use any word processor that can edit the .LWP document format and that costs less than $100. In the second part of the XML, the customer requires that presentation graphics software be Lotus Freelance, with a version later than 5.7.

FIG. 3 shows the components of the automatic provisioning system that generate and test the disk image in a preferred embodiment of the present invention. These components reside on the premises of subscription computing service provider 20. As previously described, database server 80 maintains requirements database 81 in response to requirements received from the customer. Database server 80, provisioning engine server 90, disk image manufacturing server 110 and disk image testing server 130 communicate with each other over local area network 100, which is preferably fast Ethernet adhering to the 100BaseT standard.

Provisioning engine server 90 retrieves customer requirements from database server 80, using local area network 100. Provisioning engine server 90 consults knowledge bases 91, 92 and 93 to provide context for the analysis of customer requirements, and transmits a series of provisioning orders not shown to disk image manufacturing server 110 which will store them on disk 111. These provisioning orders contain directions as to which software components are to be included in the disk image, together with configuration parameters.

The precise sequence and content of these orders is determined by provisioning engine server 90, software in accordance with knowledge bases 91, 92 and 93. Knowledge base 91 may contain rules pertaining to the construction of disk images for specific PC operating systems, knowledge base 92 may contain rules pertaining to the construction of disk images for PC applications software that is used generally in business, and knowledge base 93 may contain rules pertaining to PC application software that is specific to the industry segment of the customer.

Disk image manufacturing server 110 creates disk images on disks 120, 121 and 122 in a manner responsive to the provisioning orders stored on disk 111 and to a knowledge base 112. Knowledge base 112 contains rules pertaining to the construction of disk images in general, as opposed to the knowledge bases 91, 92 and 93, which determine which components of software are to be included in the disk image.

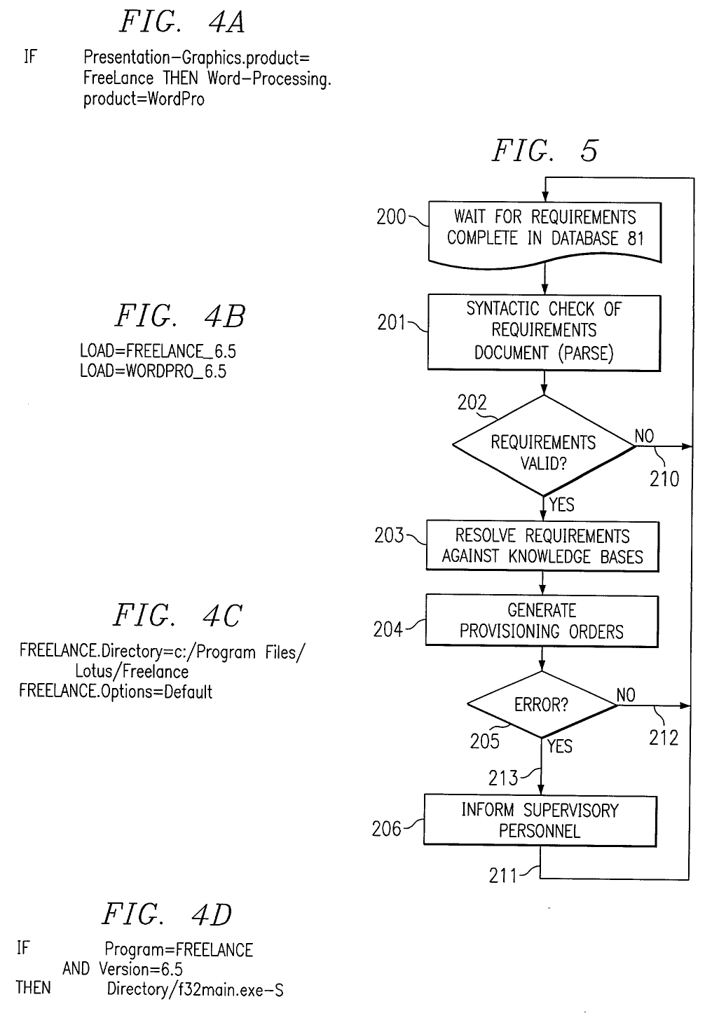

FIG. 4A gives an example of a rule that may be found in knowledge base 92 of FIG. 3, the knowledge base concerning PC applications software that is used generally in business. This rule is of the “IF condition THEN action” form. The rule states that if the chosen presentation graphics software is Freelance then the word processing software should be chosen to be WordPro. Presumably this rule is in the knowledge base for reasons of compatibility and data exchange.

FIG. 4B gives an example of provisioning orders that may be created by provisioning engine 90 and stored on disk 111. These orders specify that both Freelance and WordPro, of selected versions, be made components of the disk image to be manufactured by disk image manufacturing server 110.

FIG. 4C gives two examples of rules that may be found in knowledge base 112, pertaining to the construction of disk images in general. These rules specify where (in what subdirectory) and with what installation options the Freelance software is to be generated into the disk image.

FIG. 5 is a flowchart representation of the execution of software in provisioning engine 90 in FIG. 3 in accordance with a preferred embodiment of the present invention. In step 200, the software waits for a signal from database 81 to the effect that all of the customer approvals have been received and the customer requirements are complete. Provisioning engine 90 then accesses these requirements by communicating with database server 80 over local area network 100. When the requirements are received, the requirements are checked (step 201), typically by invoking an XML parser with an appropriate XML Schema. XML parsers are available from W3C (www.w3c.org). The xerces-j parser, a schema-driven parser is one example. The parser validates the requirements and if invalid control is transferred via branch 210 to step 200 to wait for another requirements document.

If valid, the requirements document entries are each resolved against knowledge bases 91, 92 and 93 (step 203) to generate provisioning orders (step 204). A determination is made as to whether there has been an error (step 205) and if so branch 213 is taken to step 206 to inform supervisory personnel. Since this error may have occurred because of incomplete requirements from the customer, supervisory personnel may need to correspond with the customer to obtain updated requirements. Alternatively, direct contact with the customer may be initiated. In either case, the process cycles to step 200 to await a new set of customer requirements. If there has been no error, branch 212 is taken to step 200 to await the next requirements document.

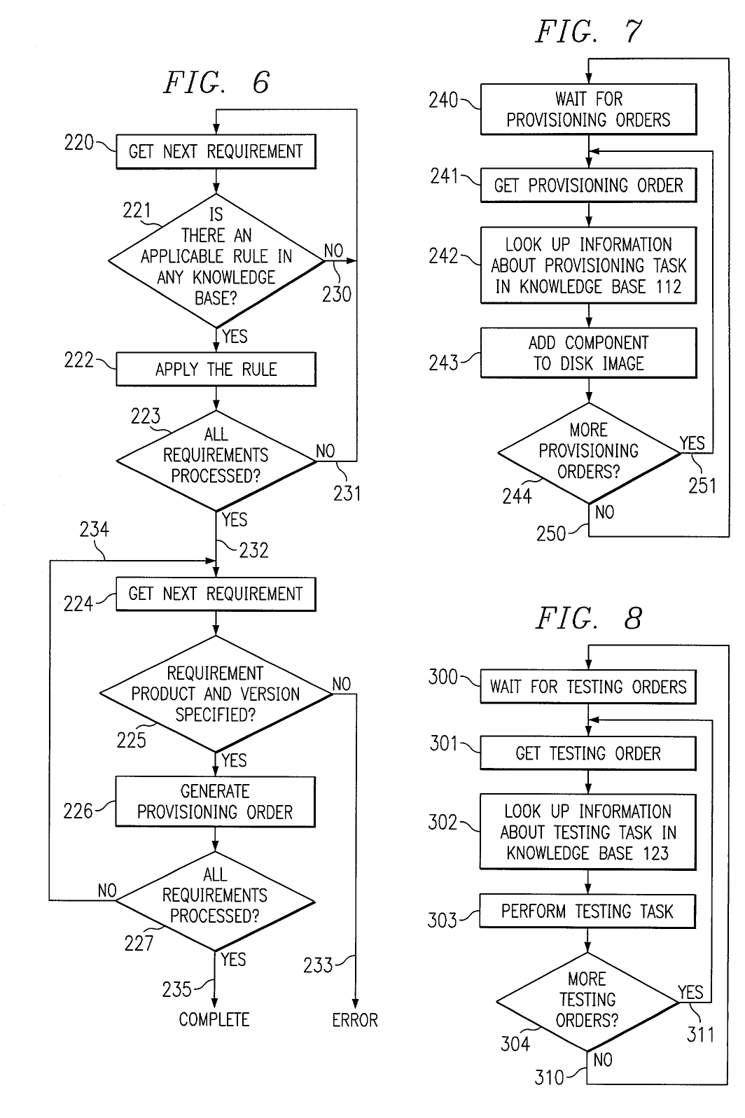

FIG. 6 provides a detailed flow of program logic in steps 203 and 204 of FIG. 5. Processing begins at step 220 where the next requirement is received from the requirements document. The knowledge databases are then scanned to find applicable rules (step 221). If there are none, branch 230 is taken to step 220 to get the next requirement. If there is at least one rule step 222 is expected and the rule applied. Rules, as shown in FIG. 4B, generally change the requirements entries by filling in product names and versions. At step 223 a check is made to see if all requirements have been processed and if not, branch 231 is taken to step 220 to get the next requirement. If so, branch 232 is taken to the next step, generation of the provisioning orders.

In step 224 the next requirement is accessed. After all of the rules in knowledge bases 91, 92 and 93 have been applied, the product and version attributes of every requirement should have been changed to specific products and versions. This is checked in decision step 225. If product and version attributes of the entry are not specified, this is an error and branch 233 is taken. If they are specified, step 226 is executed to generate a provisioning order. It may be seen by reference to FIG. 4B that in a preferred embodiment, each provisioning order contains exactly a product and version, and these are obtained from the specified attributes of the requirement. Finally, at step 227 a check is made to see if all requirements have been processed. If not, branch 234 is taken to step 224 to get the next requirement. If so, branch 235 is taken, completing the process.

FIG. 7 provides a program flow for disk image manufacturing server 110 in FIG. 3. In step 240, the arrival of provisioning orders on disk 111 of FIG. 3 is awaited. At step 241, the order is received, then all applicable information about that order is looked up in knowledge base 112 of FIG. 3. This information is retrieved typically using the product name as the primary key and the product version as the secondary key, and knowledge base 112 is preferably organized as a database (such as a relational, object-oriented, object-relational, or other type of database) indexed by primary and secondary keys. The information retrieved from knowledge base 112 is used together with the base provisioning order to add a component to the disk image (step 243). There are several methods well known in the art for performing this process. A software program may be installed by invoking its installation procedure, and supplying installation parameters retrieved from knowledge base 112. Or it may be the case that pre-installed images are available to disk image manufacturing server 110, in which case the proper image must be chosen based on information retrieved from knowledge base 112, and added to the disk image.

Once step 243 is complete, step 244 is executed to check to see if there are more provisioning orders. If so, branch 251 is taken and step 241 executed to get the next order. If not, branch 250 is taken and step 240 executed to await the next batch of provisioning orders.

In FIG. 3 is shown a disk image testing server 130 with access to generated disk images 120, 121 and 122. This access may be through a dual-port switch or through file sharing between disk image manufacturing server 110 and disk image testing server 130. The access may also be realized through the introduction of a file server not shown attached to local area network 100, on which disk image manufacturing server 110 writes disk images and from which disk image testing server 130 reads disk images. Disk image testing server 130 also requires access to the provisioning orders as created by provisioning engine 90, written to disk 111 and augmented during disk image manufacturing with information from knowledge base 112 by disk image manufacturing server 110. This list of provisioning orders is used to drive the testing process. During testing disk image testing server 130 makes reference to knowledge base 123, which contains information about how to test the disk image.

FIG. 4D is a depiction of a rule that may be found in knowledge base 123 in FIG. 3. This rule is triggered by the presence of a provisioning order such as that shown in FIG. 4B, as augmented with information added by the disk image manufacturing server 110 as depicted in FIG. 4C. The rule checks the program and version and if these match the augmented provisioning rule then the disk image testing server 130 invokes the primary executable of Freelance (f32main.exe) from the directory where that program should have been stored by disk image manufacturing server 110. The program is invoked with the S (“Silent”) option, which may indicate that any end user dialog is to be suppressed. In practice, additional rules subsequent to the rule shown in FIG. 4D would be present to check to see if the invocation of the required program produced the desired effect.

It should be appreciated that the form and language of the rules to be found in knowledge base 123 may differ from exact form of the rule shown in FIG. 4D. In particular, the language may be that of a batch or scripting language such as is found in Microsoft's DOS .BAT scripting facility.

FIG. 8 shows a program flow for disk image testing server 130 of FIG. 3. The arrival of testing orders (augmented provisioning orders from Disk image manufacturing server 110 of FIG. 3) is awaited (step 300), an order is received (step 301) and all applicable rules from knowledge base 123 of FIG. 3 are looked up (step 302). This information is retrieved typically using the product name as the primary key and the product version as the secondary key, and knowledge base 123 is preferably organized as a database indexed by primary and secondary keys. The information retrieved from knowledge base 123 is used at step 303 to test a component to the disk image, typically by invoking it with specific parameters.

Once the processing of step 303 is complete, step 304 is executed to check to see if there are more testing orders. If so, branch 311 is taken and step 301 executed to get the next order. If not, branch 310 is taken and step 300 executed to await the next batch of provisioning orders.

It may be the case that the task to be undertaken is to build a new disk image as a modification of an existing disk image rather than from scratch. This modification is initially represented as a modified set of requirements acquired from users and stored in database 81 of FIG. 2. The process as previously described can be followed without reference to any pre-existing disk image or set of requirements, and a new disk image will result. There is an optimization, however, that may be advantageous to the subscription computing service provider in reducing the time necessary to prepare the new disk image, or in reducing the resources necessary to prepare it.

In this optimization, the process as previously described is followed up to the point of generating the provisioning orders on disk 111 of FIG. 3, both for the old requirements and for the modified ones. This results in two sets of provisioning orders. Disk image manufacturing server 110 may then run a processing step to determine the difference between the two sets. Software for calculating the difference between two files is well known in the state of the art, examples being the UNIX diff utility and the TeamConsolidate feature of the Lotus WordPro word processor. Once these differences have been calculated, each difference is classified as either an addition, a deletion, or a modification of some component of the disk image.

Disk image manufacturing server 110 then runs software identical to that shown in FIG. 6 with the exception of step 243. Rather than only adding components to the disk image, step 243 involves examining each difference and adding, deleting or modifying the designated component of the disk image. Addition has been previously described. Deletion can be performed in several ways; either as the “un-installation” of the software component, or in the case that modifications can be made directly to the disk image (e.g., by file deletion) without running the software's un-installation utility, by actions directly on the disk image. Modifications are typically done by deletion followed by addition, but some software installation facilities permit incremental changes to the installation without deletion and re-installation.

With reference to the process described it can be seen that this process can be fully automated, except in the case of incomplete specifications, in which case it may be necessary to obtain more complete requirements from users or in some other manner involving human intervention. Thus, by means of the processes herein described, economical mass-customized manufacture of disk images can be achieved. It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or to be limited to the form(s) of the invention disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
receiving software requirements from each of a plurality of users; and
generating a disk image containing at least one item of software, wherein the at least one item of software complies with at least a subset of the software requirements.

2. The method of claim 1, further comprising:
applying rules to the software requirements to identify software items that comply with the software requirements.

3. The method of claim 2, wherein the rules are stored in a database.

4. The method of claim 3, wherein the rules include rules mapping a software requirement into a corresponding software item.

5. The method of claim 3, wherein the rules include rules specifying when particular versions of a particular software item are to be utilized.

6. The method of claim 3, wherein the rules include rules specifying installation options regarding a particular software item.

7. The method of claim 3, wherein the rules include rules specifying how to test a particular software item.

8. The method of claim 1, further comprising:
testing the disk image.

9. The method of claim 8, wherein testing the disk image includes verifying that the at least one item of software complies with the software requirements.

10. The method of claim 8, wherein testing the disk image includes verifying that the at least one item of software complies with at least one rule.

11. The method of claim 1, further comprising:
generating a difference image that represents differences between the disk image and another existing disk image, whereby the another existing disk image may be updated to match the disk image by applying the difference image to the another existing disk image.

12. The method of claim 1, wherein the software requirements are received through a network.

13. The method of claim 1, wherein the network includes the Internet.

14. The method of claim 1, wherein the requirements are represented in a structured format.

15. The method of claim 14, wherein the structured format is Extensible Markup Language (XML).

16. A method comprising:
parsing a plurality of inputs to extract specifications regarding software;
evaluating a plurality of rules with respect to the plurality of inputs to derive a set of software items conforming to at least the specifications;
evaluating a second plurality of rules with respect to the plurality of inputs to derive a set of configuration options conforming to at least the specifications;
storing each software item from the set of software items on a storage device;
configuring each software item stored on the storage device in accordance to the set of configuration options; and
generating a disk image from contents of the storage device.

17. The method of claim 16, wherein the plurality of inputs are requests from hypertext browsers.

18. The method of claim 16, wherein the plurality of inputs are XML documents.

19. A computer program product in a computer-readable medium comprising functional descriptive data that, when executed by a computer, enables the computer to perform acts including:
receiving software requirements from each of a plurality of users; and
generating a disk image containing at least one item of software, wherein the at least one item of software complies with at least a subset of the software requirements.

20. The computer program product of claim 19, comprising additional functional descriptive data that, when executed by the computer, enables the computer to perform additional acts including:
applying rules to the software requirements to identify software items that comply with the software requirements.

21. The computer program product of claim 20, wherein the rules are stored in a database.

22. The computer program product of claim 21, wherein the rules include rules mapping a software requirement into a corresponding software item.

23. The computer program product of claim 21, wherein the rules include rules specifying when particular versions of a particular software item are to be utilized.

24. The computer program product of claim 21, wherein the rules include rules specifying installation options regarding a particular software item.

25. The computer program product of claim 21, wherein the rules include rules specifying how to test a particular software item.

26. The computer program product of claim 19, comprising additional functional descriptive data that, when executed by the computer, enables the computer to perform additional acts including:
testing the disk image.

27. The computer program product of claim 26, wherein testing the disk image includes verifying that the at least one item of software complies with the software requirements.

28. The computer program product of claim 26, wherein testing the disk image includes verifying that the at least one item of software complies with at least one rule.

29. The computer program product of claim 19, comprising additional functional descriptive data that, when executed by the computer, enables the computer to perform additional acts including:
generating a difference image that represents differences between the disk image and another existing disk image, whereby the another existing disk image may be updated to match the disk image by applying the difference image to the another existing disk image.

30. The computer program product of claim 19, wherein the software requirements are received through a network.

31. The computer program product of claim 19, wherein the network includes the Internet.

32. The computer program product of claim 19, wherein the requirements are represented in a structured format.

33. The computer program product of claim 32, wherein the structured format is Extensible Markup Language (XML).

34. A data processing system comprising:
means for receiving software requirements from each of a plurality of users; and
means for generating a disk image containing at least one item of software, wherein the at least one item of software complies with at least a subset of the software requirements.

35. The data processing system of claim 34, further comprising:
means for applying rules to the software requirements to identify software items that comply with the software requirements.

36. The data processing system of claim 35, wherein the rules are stored in a database.

37. The data processing system of claim 36, wherein the rules include rules mapping a software requirement into a corresponding software item.

38. The data processing system of claim 36, wherein the rules include rules specifying when particular versions of a particular software item are to be utilized.

39. The data processing system of claim 36, wherein the rules include rules specifying installation options regarding a particular software item.

40. The data processing system of claim 36, wherein the rules include rules specifying how to test a particular software item.

41. The data processing system of claim 34, further comprising:
means for testing the disk image.

42. The data processing system of claim 41, wherein testing the disk image includes verifying that the at least one item of software complies with the software requirements.

43. The data processing system of claim 41, wherein testing the disk image includes verifying that the at least one item of software complies with at least one rule.

44. The data processing system of claim 34, further comprising:
means for generating a difference image that represents differences between the disk image and another existing disk image, whereby the another existing disk image may be updated to match the disk image by applying the difference image to the another existing disk image.

45. The data processing system of claim 34, wherein the software requirements are received through a network.

46. The data processing system of claim 34, wherein the network includes the Internet.

47. The data processing system of claim 34, wherein the requirements are represented in a structured format.

48. The data processing system of claim 47, wherein the structured format is Extensible Markup Language (XML).
